(19) United States
(12) Patent Application Publication
(10) Pub. No.: US 2016/0349844 A1
(43) Pub. Date: Dec. 1, 2016

(54) Magnetic Attachment Mechanism for Multifinger Haptic Device

(71) Applicant: University of Washington, Seattle, WA (US)

(72) Inventors: David Caballero Esquivel, Seattle, WA (US); Blake Hannaford, Seattle, WA (US); Mohammad Haghighipanah, Seattle, WA (US); Danying Hu, Seattle, WA (US); Muneaki Miyasaka, Seattle, WA (US); Astrini Sie, Seattle, WA (US)

(21) Appl. No.: 15/165,532

(22) Filed: May 26, 2016

Related U.S. Application Data
(60) Provisional application No. 62/166,577, filed on May 26, 2015.

(51) Int. Cl. G06F 3/01

(52) U.S. Cl. CPC G06F 3/016; G06F 3/014

(57) ABSTRACT

A device is provided including (a) a base, (b) a first interface component coupled to the base, wherein the first interface component is cylindrical, (c) a rotatable component including a second interface component positioned on a first side of the rotatable component, wherein the first interface component and the second interface component are removeably coupled to one another based on a magnetic field, and wherein the second interface component includes a concave surface approximately corresponding to the cylindrical shape of the first interface component such that the first interface component fits at least partially within the second interface component when the first interface component is coupled to the second interface component, and (d) an attachment component coupled to a second side of the rotatable component, wherein the attachment component is configured to be removeably coupled to a hand and/or finger of a user.

### CROSS-REFERENCE TO RELATED APPLICATIONS

This application claims the benefit of the filing date of U.S. Provisional Patent Application Ser. No. 62/166,577, filed May 26, 2015, which is hereby incorporated by reference in its entirety.

### BACKGROUND

Unless otherwise indicated herein, the materials described in this section are not prior art to the claims in this application and are not admitted to be prior art by inclusion in this section.

Advances in robotics, computing power, and information systems are enabling a rapid development of tele-operated robotic systems. Such tele-operated robotic systems may be controlled through use of haptic feedback. Haptic feedback is the translation of forces in a virtual environment to a physical device that can provide touch-based, a.k.a. haptic, feedback to a user of the haptic device. Both impedance type and admittance type haptic devices are available.

One example use of haptic feedback is robotic or telerobotic surgery. In telerobotic surgery, a surgeon can be located at one location which can be remote from an operating room that holds the patient. During the operation, the surgeon can view the patient using depth images provided by a depth-enabled camera in the operating room and transmitted to a local computing device. The local computing device can receive the depth images, generate a virtual environment for the surgeon, receive commands via a haptic device to control a virtual tool and corresponding surgical robot in the operating room, and generate haptic feedback that the surgeon can use to better treat the patient.

Haptic feedback can also be useful in remotely controlling exploration devices operating in hostile, dangerous, and/or unsafe environments. Example exploration devices include undersea and outer space exploration vehicles, explosive location devices, chemical sniffing (e.g., drugs, gas leaks, toxic waste) mechanisms, exploration robots, and/or other exploration devices. For example, using haptic feedback, including haptic feedback in forbidden regions, can provide additional information about an environment under exploration and/or protect the exploration device from entering a known dangerous, already-explored, or otherwise forbidden region.

In use, haptic devices include haptic interfaces to which a user can mount one or more fingers to thereby control the haptic device. Traditionally, such haptic interfaces have two main finger mount philosophies: (i) a “one-size” fits all finger mount or (ii) a finger mount that allows the user to adjust the fit during the mounting procedure. However, the first approach is not comfortable to use for long periods of time for users whose fingers do not fall within the exact fit of the finger mount. The second approach has its own drawback in that customizing the fit for each user's finger is time consuming. Further, for cases in which two haptic interfaces are being used simultaneously, the second approach requires the aid of another person to mount both of the user's hands to the device. Therefore, an improved attachment mechanism for multifinger haptic devices may be desirable.

### SUMMARY

Example devices described herein allow a user to easily and rapidly mount their fingers to a multifinger haptic device. An example device may include a base mounted on the haptic device and a first interface component coupled to the user's finger via an attachment component. When the user operates the haptic device, the base and the first interface component may be attached to each other magnetically through a permanent magnet integrated into either the first interface component or the base. The device may also include a magnetic second interface component attached to the base. Mating surfaces on the fingertip may engage the magnetic second interface component with a precision sliding fit. With this mechanism design, the user may easily mount and demount from the multifinger haptic device without any assistance.

Thus, in one aspect, a device is provided including (a) a base, (b) a first interface component coupled to the base, wherein the first interface component is cylindrical in shape, (c) a rotatable component including a second interface component positioned on a first side of the rotatable component, wherein the first interface component and the second interface component are removeably coupled to one another based on a magnetic field, and wherein the second interface component includes a concave surface approximately corresponding to the cylindrical shape of the first interface component such that the first interface component fits at least partially within the second interface component when the first interface component is coupled to the second interface component, and (d) an attachment component coupled to a second side of the rotatable component, wherein the attachment component is configured to be removeably coupled to a hand and/or finger of a user.

In a second aspect, a device is provided including (a) a base, (b) a first interface component coupled to the base, wherein the first interface component includes a concave surface, (c) a rotatable component including a second interface component positioned on a first side of the rotatable component, wherein the first interface component and the second interface component are removeably coupled to one another based on a magnetic field, and wherein the second interface component includes a cylindrical shape approximately corresponding to the concave surface of the first interface component such that the second interface component fits at least partially within the first interface component when the first interface component is coupled to the second interface component, and (d) an attachment component coupled to a second side of the rotatable component, wherein the attachment component is configured to be removeably coupled to a hand and/or finger of a user.

In a third aspect, a system is provided including (a) a haptic device including a plurality of input interfaces, wherein each of the plurality of input interfaces includes: (i) a base, and (ii) a first interface component coupled to the base, wherein the first interface component is cylindrical in shape, (b) a plurality of rotatable components, wherein each of the plurality of rotatable components includes a second interface component positioned on a first side of each rotatable component, wherein each first interface component is removeably coupled to a corresponding second interface component based on a magnetic field, and wherein each second interface component includes a concave surface approximately corresponding to the cylindrical shape of each first interface component such that each first interface component fits at least partially within the corresponding second interface component when each first interface component is coupled to the corresponding second interface component, (c) one or more attachment components each coupled to a second side of a corresponding rotatable component, wherein the one or more attachment components comprise one or more of a glove, one or more rings, or one or more cylinders with a closed end.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a perspective view of a device, according to an example embodiment.

FIG. 2 is a perspective exploded view of the device, according to the example embodiment of FIG. 1.

FIG. 3 is a side exploded view of the device, according to the example embodiment of FIG. 1.

FIG. 4 shows an example attachment component, according to an example embodiment.

FIG. 5 shows another example attachment component, according to an example embodiment.

FIG. 6 shows another example attachment component, according to an example embodiment.

FIG. 7 is a side view of various components of the device, according to the example embodiment of FIG. 1.

FIG. 8 is a perspective view of the base of the device, according to the example embodiment of FIG. 1.

FIG. 9 is a top view of the base of the device, according to the example embodiment of FIG. 1.

FIG. 10 is a perspective view of the rotatable component of the device, according to the example embodiment of FIG. 1.

FIG. 11 is a side view of the rotatable component of the device, according to the example embodiment of FIG. 1.

FIG. 12 is a top view of the rotatable component of the device, according to the example embodiment of FIG. 1.

FIG. 13 is a haptic device, according to an example embodiment.

FIG. 14 is a system including an attachment component, according to an example embodiment.

FIG. 15 is a system including another attachment component, according to an example embodiment.

FIG. 16 is a block diagram of an example computing network, in accordance with an embodiment.

FIG. 17 is a block diagram of an example computing device, in accordance with an embodiment.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

As used herein, with respect to measurements, “about” means +/−5%.

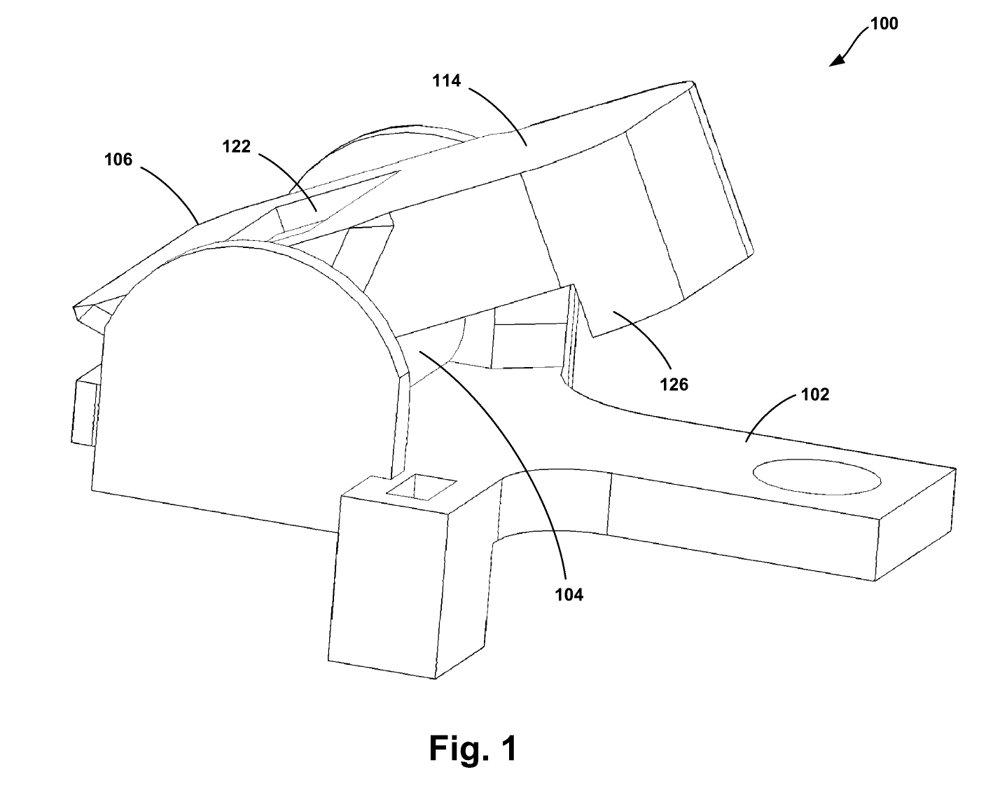

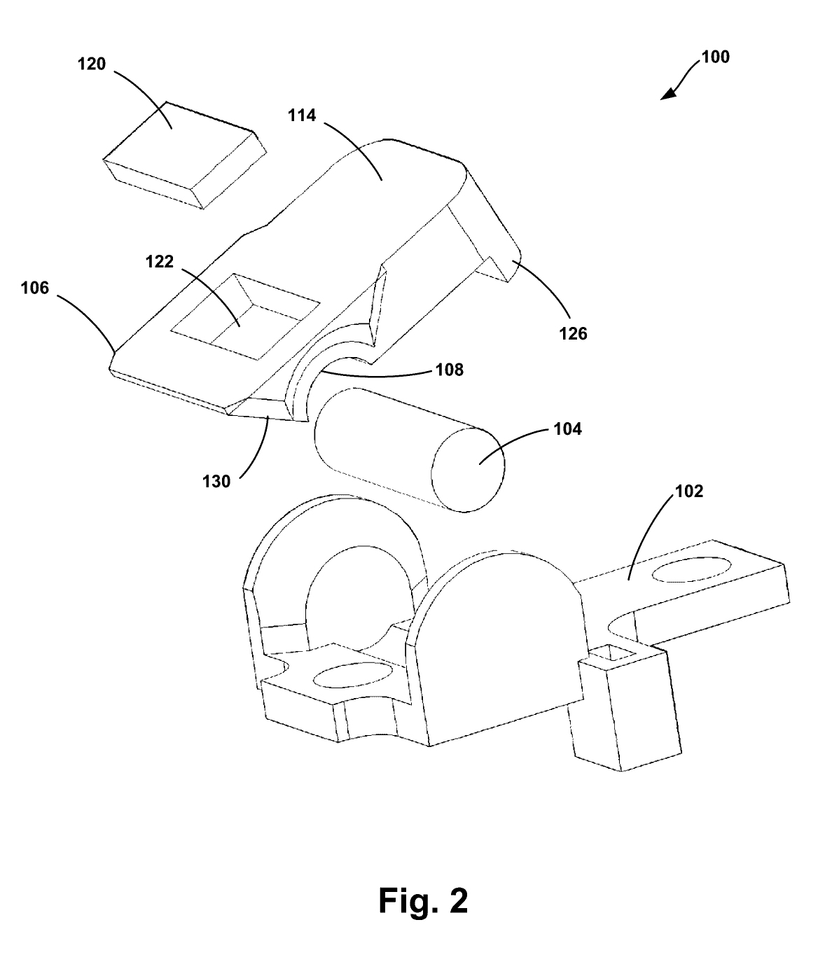

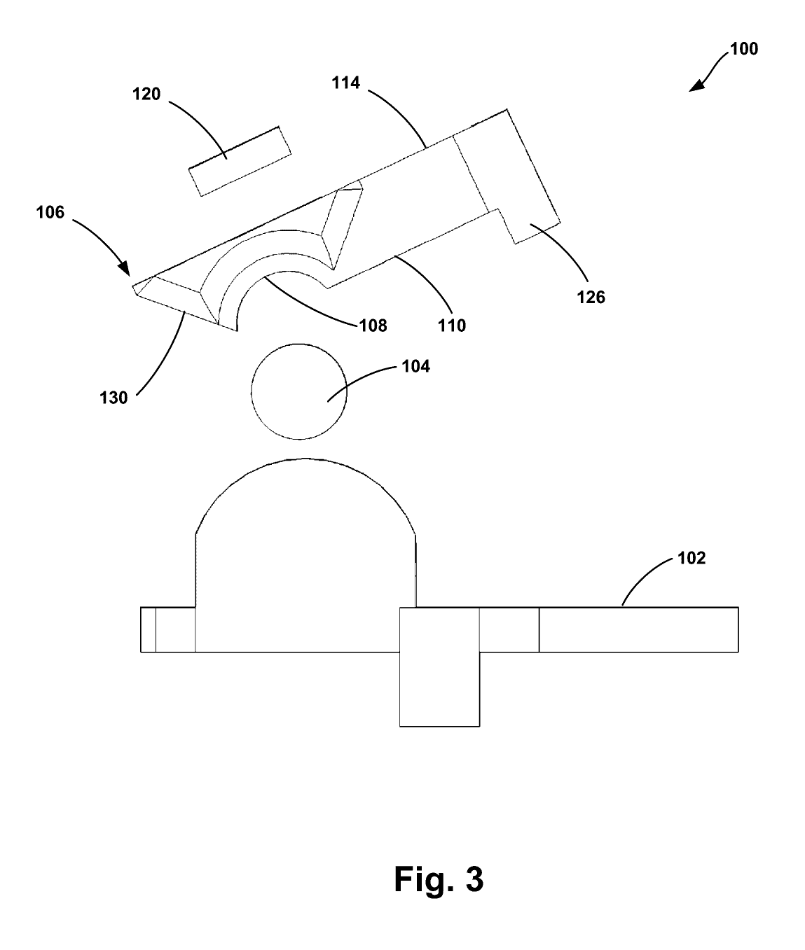

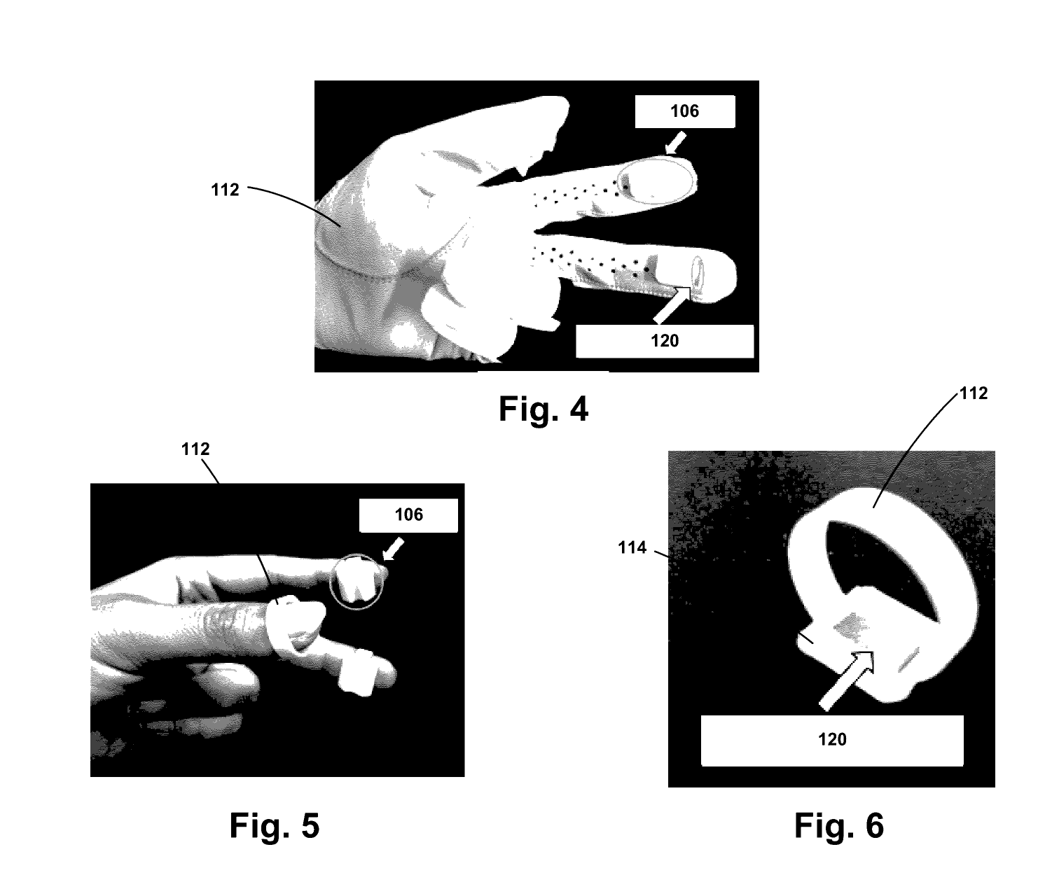

The present disclosure provides various devices for quickly and efficiently coupling and decoupling a user's fingers to a haptic device. In particular, with reference to the Figures, FIGS. 1-3 illustrates a device 100 according to an example embodiment. In particular, FIG. 1 illustrates a perspective view of an example device 100. As shown in FIG. 1, the device 100 may include a base 102 with a first interface component 104 coupled to the base 102. As seen in FIGS. 2-3, the first interface component 104 is cylindrical in shape. The device 100 may further include a rotatable component 106 including a second interface component 108 positioned on a first side 110 of the rotatable component 106. The first interface component 104 and the second interface component 108 are removeably coupled to one another based on a magnetic field. Further, the second interface component 108 may include a concave surface approximately corresponding to the cylindrical shape of the first interface component 104 such that the first interface component 104 fits at least partially within the second interface component 108 when the first interface component 104 is coupled to the second interface component 108. The device 100 may further include an attachment component 112 coupled to a second side 114 of the rotatable component 106. Example attachment components 112 are shown in FIGS. 4-6. As shown in FIGS. 4-6, the attachment component 112 is configured to be removeably coupled to a hand and/or finger of a user, as discussed in additional detail below.

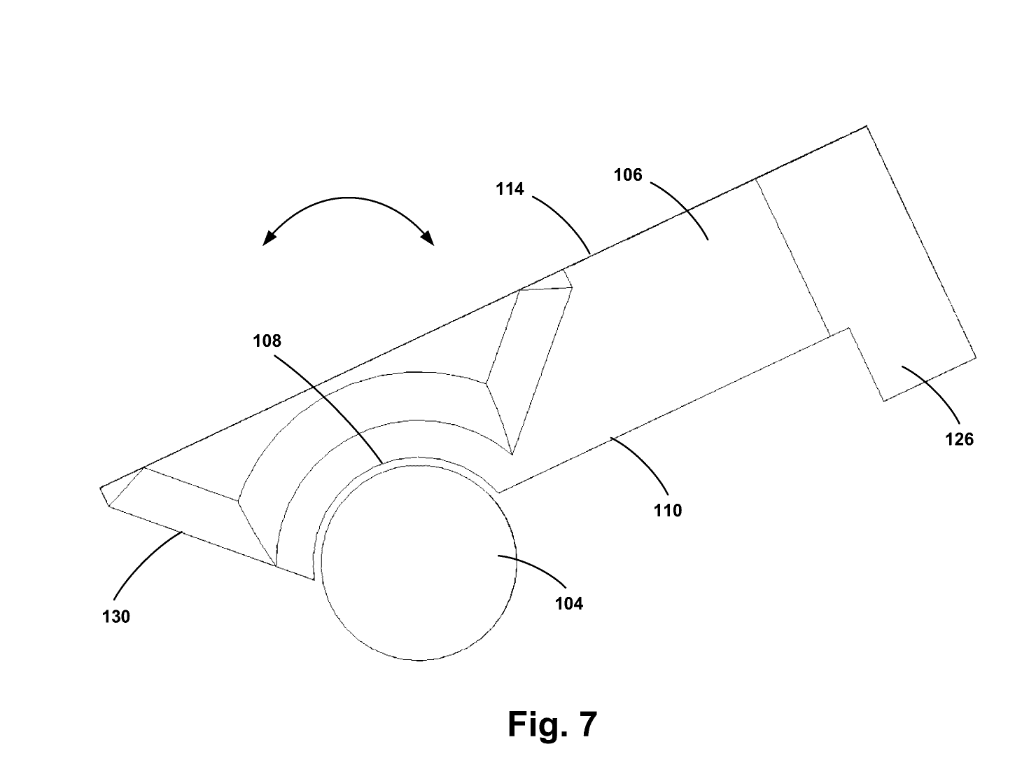

FIG. 7 illustrates a side view of the device 100 with the base 102 removed. As shown in FIG. 7, the second interface component 108 is pivotably coupled to the first interface component 104. In such an example, the rotatable component 106 is configured to rotate with respect to the base 102 when the device 100 is in use. The range of rotation of the rotatable component 106 with respect to the base 102 may range based on the particular configuration of the rotatable component 106. For example, in the configuration shown in FIG. 7, the range of rotation of the rotatable component 106 with respect to the base 102 may be between about 45 degrees and about 0 degrees. In the example shown in FIGS. 5-6, the range of rotation of the rotatable component 106 with respect to the base 102 may be between about −60 degrees and about +60 degrees. In the examples described above, the angle of rotation of the rotatable component 106 is 0 degrees when the second surface 114 of the rotatable component 106 is parallel to the top surface of the base 102.

In the embodiments described above, the second interface component 108 may be slidably coupled to the first interface component 104 such that the surface of the second interface component 108 may move along a surface of the first interface component 104 without losing contact. Such a configuration may be advantageous when operating a haptic device using the device 100. In such a configuration, the lateral motion of the rotatable component 106 with respect to the first interface component 104 comprises a first degree of freedom, while rotation of the rotatable component 106 with respect to the base 102 about the main axis of the first interface component 104 comprises a second degree of freedom. In embodiments, the movement along the second degree of freedom is linear and/or only along the main axis of the first interface component 104. Embodiments of the invention may also allow a rotational movement to occur only about a single axis, rather than multiple axes. This restricted manner of motion may provide a preferred combination of adjustable fit about the single axis but firm responsiveness and control of the manual interface along other axes defined by the components.

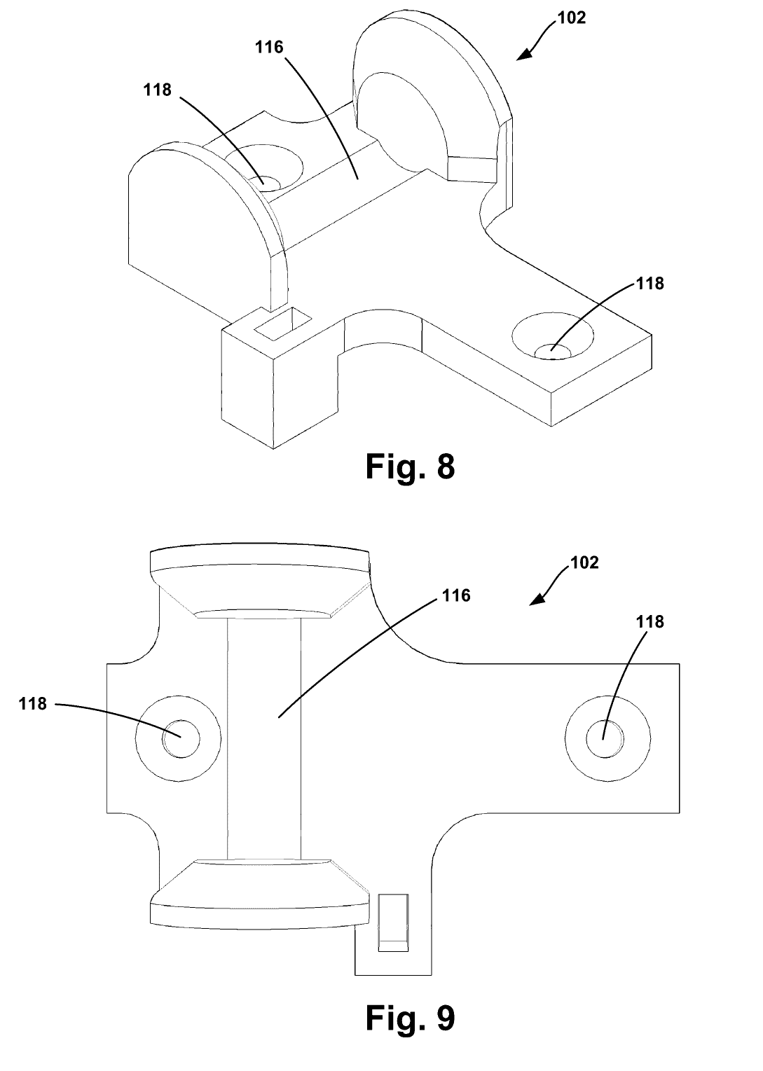

FIGS. 8-9 illustrate the base 102 of the device 100 in additional detail. In particular, FIG. 8 illustrates a perspective view of the base 102 of the device 100, while FIG. 9 illustrates a top view of the base 102 of the device 100. As shown in FIGS. 8-9, the top surface of the base 102 may include a concave shaped section 116 configured to receive the cylindrically shaped first interface component 104. In one example, the first interface component 104 may be positioned in the concave shaped section 116 such that the first interface component is rotationally fixed relative to the base 102. In another example, the first interface component 104 is coupled to the base 102 such that the first interface component 104 can rotate with respect to the base 102. Further, the base 102 may include a bottom surface that is substantially planar and one or more mounting holes 118 that are sized, shaped, and/or positioned to mount the base 102 to a haptic device, as discussed in additional detail below.

As described above, the first interface component 104 and the second interface component 108 are removeably coupled to one another based on a magnetic field. In one example, the magnetic field is generated by a permanent magnet 120 positioned adjacent to the second interface component 108. In such an example, the permanent magnet 120 is coupled to a non-magnetic material of the rotatable component 106. In such an example, the first interface component 104 comprises a ferromagnetic material, such as iron or stainless steel as examples. As such, the permanent magnet 120 causes the first interface component 104 and the second interface component 108 to become removeably coupled to one another when the first interface component 104 and the second interface component 108 are brought together. In one example, the non-magnetic material of the rotatable component 106 includes a cutout 122. As shown in FIGS. 1-2, the cutout 122 may be shaped to match the shape of the permanent magnet 120. In addition, the cutout 122 and the second interface component 108 are on opposite sides of the rotatable component 106. Although the cutout 122 and permanent magnet 120 are shown as rectangular in shape, other shapes for these components are possible as well.

In one example embodiment, at least a portion of the cutout 122 and at least a portion of the surface of the second interface component 108 connect such that the permanent magnet 120 contacts the first interface component 104 when the first interface component 104 is coupled to the second interface component 108. Such a configuration may provide a stronger coupling of the first interface component 104 to the second interface component 108. In another example embodiment, a portion of the non-magnetic material of the rotatable component 106 is positioned between the permanent magnet 120 and the first interface component 104 when the first interface component 104 is coupled to the second interface component 108.

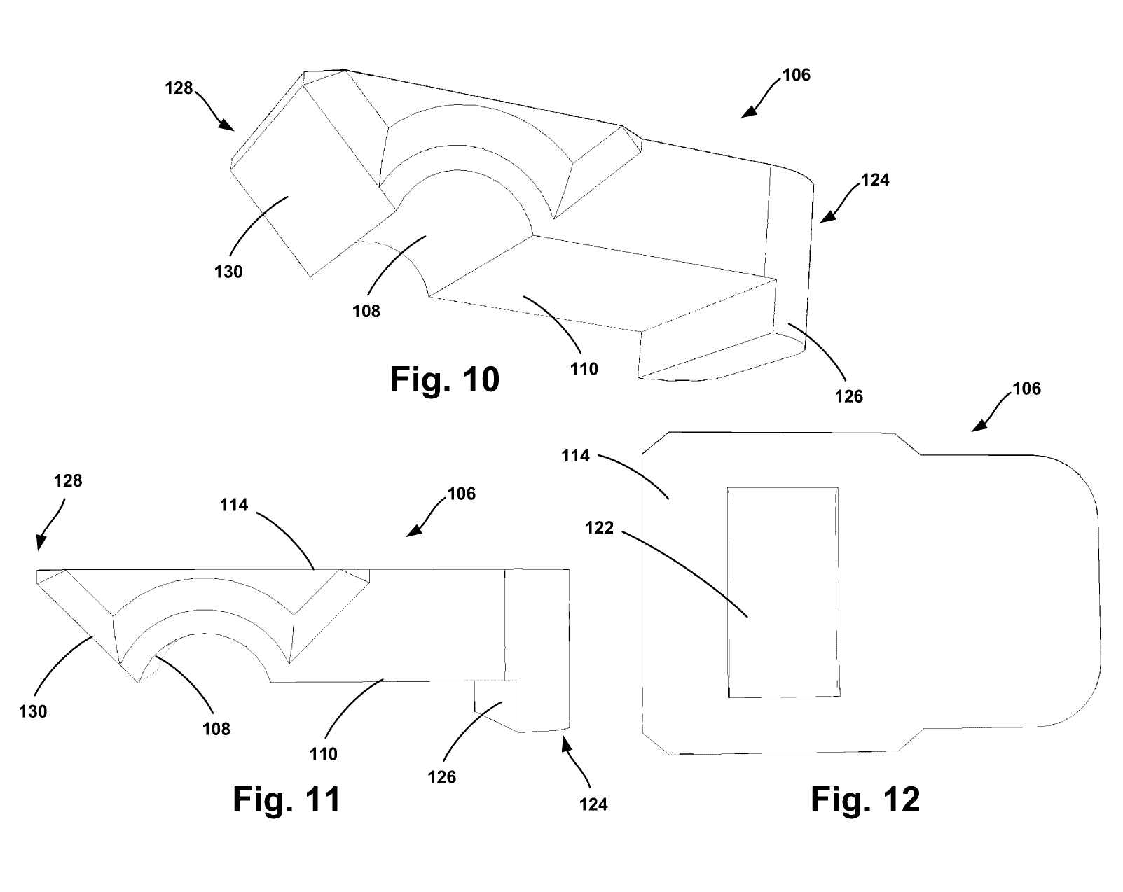

FIGS. 10-12 illustrate the rotatable component 106 of the device 100 in additional detail. In particular, FIG. 10 illustrates a perspective view of the rotatable component 106, FIG. 11 illustrates a side view of the rotatable component 106, and FIG. 12 illustrates a top view of the rotatable component 106. As shown in FIGS. 10-11, the first end 124 of the rotatable device 106 may include a protrusion 126. In use, the size and/or position of the protrusion 126 limits a range of motion of the rotatable component 106 with respect to the base 102. In one example, as shown in FIGS. 10-11, the protrusion 126 extends away from the first surface 110 of the rotatable component 106. In such an example, the distance the protrusion 126 extends away from the first surface 110 of the rotatable component 106 is such that the second surface 114 of the rotatable component 106 is substantially parallel to the top surface of the base 102 when the protrusion 126 contacts the top surface of the base 102. In another example, as shown in FIGS. 10-11, the second end 128 of the rotatable component 106 may include an angled surface 130. The angled surface 130 may correspond to a maximum angle of rotation of the rotatable component 106 with respect to the base 102. For example, the angled surface 130 shown in FIG. 11 is approximately 45 degrees. As such, during operation the rotatable component 106 may have a maximum angle of rotation of 45 degrees with respect to the base 102, as the angled surface 130 contacts the top surface of the base 102 at that angle of rotation.

As described above and as shown in FIG. 12, the second side 114 of the rotatable component 106 may include a cutout 122 shaped to receive a permanent magnet 120. In one example, the permanent magnet 120 may be permanently fixed in the cutout 122. For example, the permanent magnet 120 may be press fit into the cutout 122, or glued into the cutout 122.

In another example, the rotatable component 106 includes a decoupling mechanism to removeably couple the permanent magnet 120 from the cutout 122 in the non-magnetic material. Such a decoupling mechanism may take a variety of forms. In one example, the decoupling mechanism comprises a fabric that has a first end fixed to the bottom of the cutout 122, and a second end extending outside of the cutout 122. In such an example, the permanent magnet 120 may be press fit into the cutout 120. A user could pull the second end of the fabric to pop the permanent magnet 120 out of the cutout 122 when desired. In another example, the decoupling mechanism comprises a cover positioned over the top of the cutout 122. The cover may include a hinge on one side with a latch on the opposing side, or may simply include a latch that can be used to open and close the cover. In such an example, the permanent magnet 120 may be positioned in the cutout 122, and the cover may be placed over the top of the cutout 122 to hold the permanent magnet 120 in place. A user could remove the cover to thereby remove the permanent magnet 120 when desired. Other decoupling mechanisms are possible as well. Such decoupling mechanisms may enable a user to quickly swap out the permanent magnet 120. This may be advantageous to adjust the magnetic strength of the permanent magnet 120 of the device 100 based on the particular function to be performed in use of the haptic device to which device 100 is coupled.

In another embodiment of the device 100, the first interface component 104 and the second interface component 108 are removeably coupled to one another based on a magnetic field generated by the first interface component 104. In such an example, the cylindrically shaped first interface component 104 is a permanent magnet, and the second interface component includes a ferromagnetic material that is magnetically attracted to the permanent magnet.

In yet another example embodiment, the device may take a slightly different form than the device 100 shown in FIGS. 1-12. In such an example, the device may include a base, and a first interface component coupled to the base. The first interface component may include a concave surface. Further, the device may include a rotatable component including a second interface component positioned on a first side of the rotatable component. The first interface component and the second interface component are removeably coupled to one another based on a magnetic field, and the second interface component includes a cylindrical shape approximately corresponding to the concave surface of the first interface component such that the second interface component fits at least partially within the first interface component when the first interface component is coupled to the second interface component. The device may further include an attachment component coupled to a second side of the rotatable component. The attachment component is configured to be removeably coupled to a hand and/or finger of a user.

As such, the device of this embodiment is similar to the device 100 shown in FIGS. 1-12, with the exception that the cylindrically shaped interface component is coupled to the rotatable component instead of coupled to the base. In such an example, the permanent magnet may be positioned in a cutout in the base instead of a cutout in the rotatable component.

Each of the embodiments described above include an attachment mechanism coupled to the rotatable component. As shown in FIGS. 4-6, the attachment component 112 may take a variety of forms. In one example, as shown in FIG. 4, the attachment component 112 comprises a glove that may be positioned on hand of a user. In such an example, there may be a plurality of sizes for the gloves, such as small, medium, large, and extra-large to fit a variety of users. The rotatable component 106 may be coupled to the glove in a variety of ways. For example, the rotatable component 106 may be glued to the glove, the rotatable component 106 may be manufactured as an integral component of the glove, or the rotatable component 106 may be sewn to the glove 106.

In another example, the rotatable component 106 may be removeably coupled to the glove. For example, the rotatable component 106 may include an insert which may be inserted into a pocket sewn into the fingertip of the glove. In another example, the fingertip of the glove may include a ferromagnetic material that is attracted to the permanent magnet 120. In yet another example, the second surface 114 of the rotatable component 106 and the fingertip of the glove may include a hook and loop fastener. Other coupling examples are possible as well. Such temporary coupling of the rotatable component 106 to the attachment component 112 may enable a user to quickly swap out the rotatable component 106 to adjust the magnetic strength of the permanent magnet 120 positioned in the cutout 122 of the rotatable component 106. This may be advantageous to adjust the magnetic strength of the permanent magnet 120 of the device 100 based on the particular function to be performed in use of the haptic device to which device 100 is coupled.

In another example, as shown in FIGS. 5-6, the attachment component 112 comprises a ring that may be positioned on a finger of a user. In one example, the ring may be adjustable to fit a given finger of the user. In yet another example, the attachment component 112 comprises a cylinder with a closed end, such as a thimble. In such an example, the rotatable component 106 may be coupled to the thimble using one or more of the coupling mechanisms described above in relation to the glove.

In certain embodiments, such as shown in any one of FIGS. 1-12, example devices or components thereof may be made using an additive-manufacturing process, such as stereolithography. As such, the example filtration devices described above may include a variety of materials, including calcium carbonate of poly(dimethylsiloxane) (PDMS), as examples. In one example, the additive-manufacturing process is a multi-material additive-manufacturing process such that various components of the device may be formed using a material with a greater elasticity than the other components.

Each of the devices and components described in FIGS. 1-12 may represent a module, a segment, or a portion of program code, which includes one or more instructions executable by a processor or computing device for creating such devices using an additive-manufacturing system. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

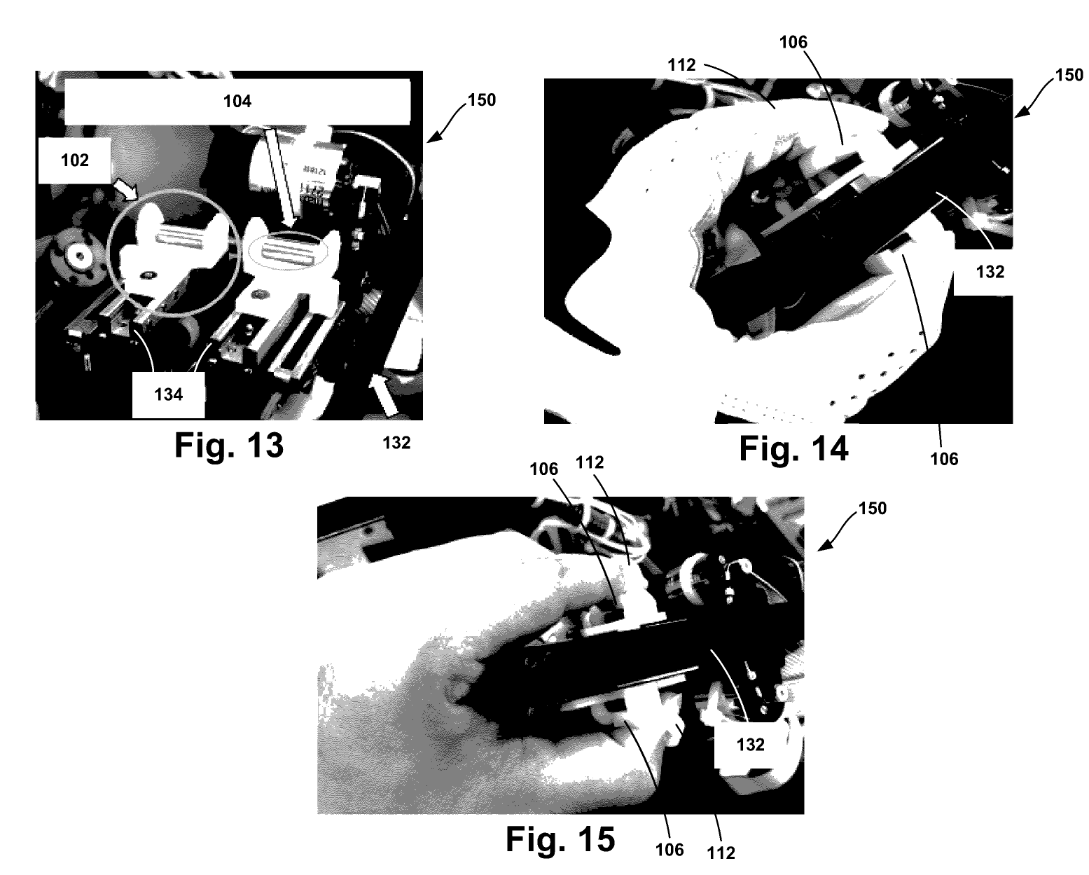

FIGS. 13-15 illustrate a system 150, according to an example embodiment. As shown in FIGS. 13-15, the system 150 may include a haptic device 132 including a plurality of input interfaces 134. The device 100 described above in relation to FIGS. 1-12 may be sized and shaped to be retrofit to couple to one or more input interfaces 134 of an existing haptic device 132. As such, each of the plurality of input interfaces includes: (i) a base 102, and (ii) a first interface component 104 coupled to the base 102. As shown in FIGS. 13-15, the first interface component 104 is cylindrical in shape. In one example, each of the plurality of input interfaces 134 is slideably coupled to the haptic device 132. In such an example, each base 102 can slide relative to the rest of the haptic device 132 when in use.

The system 150 further includes a plurality of rotatable components 106. Each of the plurality of rotatable components 106 includes a second interface component 108 positioned on a first side 110 of each rotatable component 106. Further, wherein each first interface component 104 is removeably coupled to a corresponding second interface component 108 based on a magnetic field. In addition, each rotatable component 106 includes a concave surface approximately corresponding to the cylindrical shape of each first interface component 104 such that each first interface component 104 fits at least partially within the corresponding second interface component 108 when each first interface component 104 is coupled to the corresponding second interface component 108.

In one example, the second interface component 108 of each of the plurality of rotatable components 106 includes a permanent magnet 120 positioned adjacent to each second interface component 108. Such permanent magnets 120 may include one or more of the features of the permanent magnet 120 described above, and may be coupled to a non-magnetic material. Further, in one embodiment each permanent magnet 120 has a different magnetic strength. As such, the plurality of rotatable components 106 are each coupled to a corresponding first interface component 104 via a different magnetic strength.

The system 150 further includes one or more attachment components 112 each coupled to a second side 114 of a corresponding rotatable component 106. As discussed above in relation to FIGS. 4-6, the one or more attachment components 112 comprise one or more of a glove, one or more rings, or one or more cylinders with a closed end.

In operation, a user may position the attachment components 112 of the system 150 on their hand (in the case of a glove) or their fingers (in the case of the rings and/or thimbles). The base 102 and first interface component 104 may be coupled to the haptic interfaces 134 of the haptic device 132. The user may then snap each rotatable component 106 onto a corresponding first interface component 104. The haptic device 132 shown in FIGS. 13-15 includes three haptic interfaces 134 for three fingers of the user, but the devices described herein allow for any number of haptic interfaces. The magnetic force between the rotatable component 106 and the first interface component 104 hold the two components together during use. The user may then perform one or more operations on the haptic device 132. For example, the user may move the surface of the second interface component 108 along a surface of the first interface component 104, the user rotate the rotatable component 106 relative to the base 102, or the user may slide the base 102 relative to the rest of the haptic device 132. Each of these movements may correspond to a different function of the haptic device 132.

As described above, when performing various operations using the haptic device 132, it may be advantageous to have the ability to adjust the magnetic strength coupling the rotatable component 106 to the first interface component 104. Therefore, in one example, a user may be able to switch between different gloves having different permanent magnets with varying magnetic strengths. For example, a first pair of gloves may have stronger permanent magnets for a first set of functions to be performed using the haptic device 132, and a second pair of gloves may have weaker permanent magnets for a second set of functions to be performed using the haptic device 132. In another example, the plurality of rotatable components 106 on a glove may each include a different permanent magnet having a different magnetic strength. In yet another example, the rotatable component 106 includes a decoupling mechanism to removeably couple the permanent magnet 120 from the non-magnetic material, as discussed in detail above.

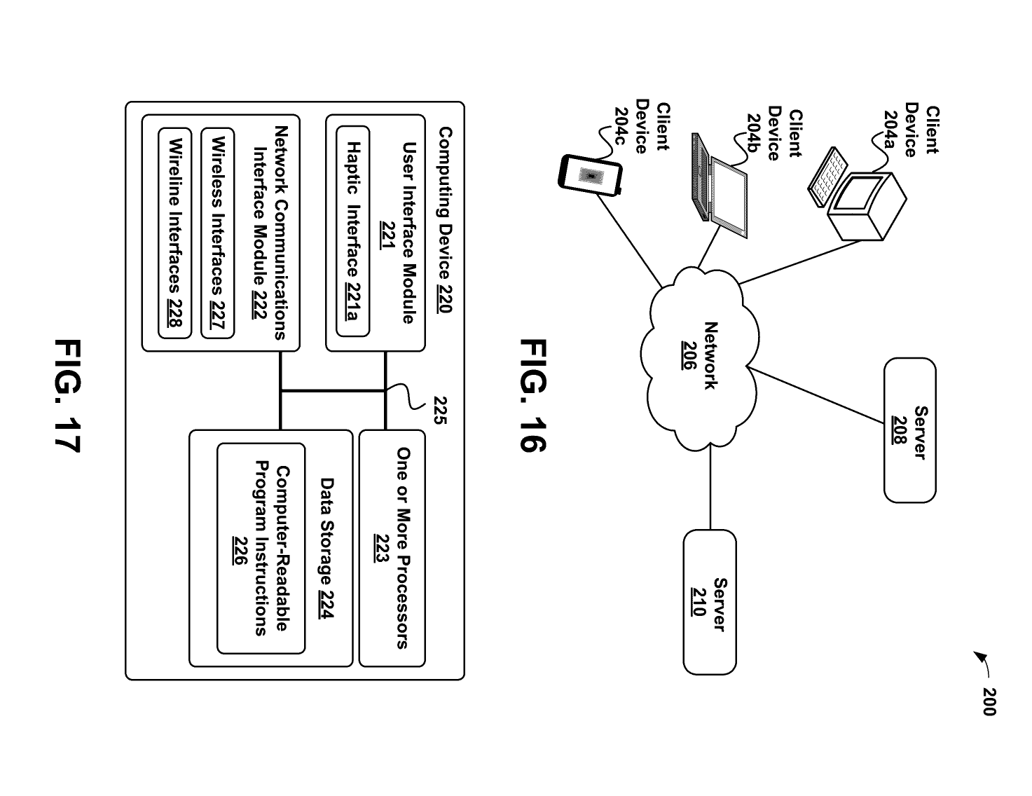

As discussed above, the devices described in FIGS. 1-12 may be sized, shaped, and/or positioned for attachment to a haptic device, such as haptic device 132. Such a haptic device may operate in a computing network, such as example computing network 200 shown in FIG. 16. In FIG. 16, servers 208 and 210 are configured to communicate, via a network 206, with client devices 204a, 204b, and 204c. As shown in FIG. 16, client devices can include a personal computer 204a, a laptop computer 204b, and a smart-phone 204c. More generally, client devices 204a-204c (or any additional client devices) can be any sort of computing device, such as a workstation, network terminal, desktop computer, laptop computer, wireless communication device (e.g., a cell phone or smart phone), and so on.

The network 206 can correspond to a local area network, a wide area network, a corporate intranet, the public Internet, combinations thereof, or any other type of network(s) configured to provide communication between networked computing devices. In some embodiments, part or all of the communication between networked computing devices can be secured.

Servers 208 and 210 can share content and/or provide content to client devices 204a-204c. As shown in FIG. 16, servers 208 and 210 are not physically at the same location. Alternatively, recipe servers 208 and 210 can be co-located, and/or can be accessible via a network separate from network 206. Although FIG. 16 shows three client devices and two servers, network 206 can service more or fewer than three client devices and/or more or fewer than two servers.

FIG. 17 is a block diagram of an example computing device 220 including user interface module 221, network-communication interface module 222, one or more processors 223, and data storage 224, in accordance with embodiments of the invention.

In particular, computing device 220 shown in FIG. 16 can be configured to perform one or more functions of client devices 204a-204c, network 206, and/or servers 208, 210. Computing device 220 may include a user interface module 221, a network-communication interface module 222, one or more processors 223, and data storage 224, all of which may be linked together via a system bus, network, or other connection mechanism 225.

Computing device 220 can be a desktop computer, laptop or notebook computer, personal data assistant (PDA), mobile phone, embedded processor, or any similar device that is equipped with at least one processing unit capable of executing machine-language instructions that implement at least part of the herein-described techniques and methods.

User interface 221 can receive input and/or provide output, perhaps to a user. User interface 221 can be configured to send and/or receive data to and/or from user input from input device(s), such as a keyboard, a keypad, a touch screen, a computer mouse, a track ball, a joystick, and/or other similar devices configured to receive input from a user of the computing device 220. User interface 221 can be configured to provide output to output display devices, such as one or more cathode ray tubes (CRTs), liquid crystal displays (LCDs), light emitting diodes (LEDs), displays using digital light processing (DLP) technology, printers, light bulbs, and/or other similar devices capable of displaying graphical, textual, and/or numerical information to a user of computing device 220. User interface module 221 can also be configured to generate audible output(s), such as a speaker, speaker jack, audio output port, audio output device, earphones, and/or other similar devices configured to convey sound and/or audible information to a user of computing device 220. As shown in FIG. 17, user interface 221 can be configured with haptic interface 221a that can receive inputs from a remote device configured to be controlled by haptic interface 221a, and provide haptic outputs such as tactile feedback, vibrations, forces, motions, and/or other touch-related outputs. In particular, the haptic interface 221a may comprise one or more of the components of device 100 described above in relation to FIGS. 1-15.

Network-communication interface module 222 can be configured to send and receive data over wireless interfaces 227 and/or wired interfaces 228 via a network, such as network 206. Wired interface(s) 228, if present, can comprise a wire, cable, fiber-optic link and/or similar physical connection to a data network, such as a wide area network (WAN), a local area network (LAN), one or more public data networks, such as the Internet, one or more private data networks, or any combination of such networks. Wireless interface(s) 227 if present, can utilize an air interface, such as a ZigBee, Wi-Fi, and/or WiMAX interface to a data network, such as a WAN, a LAN, one or more public data networks (e.g., the Internet), one or more private data networks, or any combination of public and private data networks.

In some embodiments, network-communication interface module 222 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well as or in addition to those listed herein to secure (and then decrypt/decode) communications.

Processor(s) 223 can include one or more central processing units, computer processors, mobile processors, digital signal processors (DSPs), microprocessors, computer chips, and/or other processing units configured to execute machine-language instructions and process data. Processor(s) 223 can be configured to execute computer-readable program instructions 226 that are contained in data storage 224 and/or other instructions as described herein.

Data storage 224 can include one or more physical and/or non-transitory storage devices, such as read-only memory (ROM), random access memory (RAM), removable-disk-drive memory, hard-disk memory, magnetic-tape memory, flash memory, and/or other storage devices. Data storage 224 can include one or more physical and/or non-transitory storage devices with at least enough combined storage capacity to contain computer-readable program instructions 226 and any associated/related data structures.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

We claim:

1. A device comprising:
a base;
a first interface component coupled to the base, wherein the first interface component is cylindrical in shape;
a rotatable component including a second interface component positioned on a first side of the rotatable component, wherein the first interface component and the second interface component are removeably coupled to one another based on a magnetic field, and wherein the second interface component includes a concave surface approximately corresponding to the cylindrical shape of the first interface component such that the first interface component fits at least partially within the second interface component when the first interface component is coupled to the second interface component; and
an attachment component coupled to a second side of the rotatable component, wherein the attachment component is configured to be removeably coupled to a hand and/or finger of a user.

2. The device of claim 1, wherein the second interface component is pivotably coupled to the first interface component.

3. The device of claim 2, wherein the rotatable component is configured to rotate with respect to the base, and wherein a range of the rotation of the rotatable component with respect to the base is between +60 degrees and about +60 degrees.

4. The device of claim 1, wherein the second interface component is slidably coupled to the first interface component such that the surface of the second interface component may move along a surface of the first interface component without losing contact.

5. The device of claim 1, wherein the rotatable component includes a permanent magnet positioned adjacent to the second interface component, and wherein the permanent magnet is coupled to a non-magnetic material of the rotatable component.

6. The device of claim 5, wherein the first interface component comprises a ferromagnetic material.

7. The device of claim 5, wherein the non-magnetic material of the rotatable component comprises:
a cutout shaped to match a shape of the permanent magnet, wherein the cutout and the second interface component are on opposite sides of the rotatable component.

8. The device of claim 7, wherein at least a portion of the cutout and at least a portion of the surface of the second interface component connect such that the permanent magnet contacts the first interface component when the first interface component is coupled to the second interface component.

9. The device of claim 5, wherein a portion of the non-magnetic material is positioned between the permanent magnet and the first interface component when the first interface component is coupled to the second interface component.

10. The device of claim 5, wherein the rotatable component includes a decoupling mechanism to removeably couple the permanent magnet from the non-magnetic material.

11. The device of claim 1, wherein the base comprises a substantially planar surface and/or one or more attachment mechanisms that are sized, shaped, and/or positioned for attachment to a haptic device.

12. The device of claim 1, wherein a first end of the rotatable component includes a protrusion, wherein a size and/or a position of the protrusion limits a range of motion of the rotatable component relative to the base.

13. The device of claim 1, wherein a second end of the rotatable component includes an angled surface, wherein an angle of the angled surface corresponds to a maximum angle of rotation of the rotatable component with respect to the base.

14. The device of claim 1, wherein the attachment component comprises one or more of a glove, a ring, or a cylinder with a closed end.

15. A non-transitory computer readable medium having stored thereon instructions, that when executed by one or more processors, cause an additive manufacturing machine to create one or more components of the device of claim 1.

16. A device comprising:
a base;
a first interface component coupled to the base, wherein the first interface component includes a concave surface;
a rotatable component including a second interface component positioned on a first side of the rotatable component, wherein the first interface component and the second interface component are removeably coupled to one another based on a magnetic field, and wherein the second interface component includes a cylindrical shape approximately corresponding to the concave surface of the first interface component such that the second interface component fits at least partially within the first interface component when the first interface component is coupled to the second interface component; and
an attachment component coupled to a second side of the rotatable component, wherein the attachment component is configured to be removeably coupled to a hand and/or finger of a user.

17. A system comprising:
a haptic device including a plurality of input interfaces, wherein each of the plurality of input interfaces includes: (i) a base, and (ii) a first interface component coupled to the base, wherein the first interface component is cylindrical in shape;
a plurality of rotatable components, wherein each of the plurality of rotatable components includes a second interface component positioned on a first side of each rotatable component, wherein each first interface component is removeably coupled to a corresponding second interface component based on a magnetic field, and wherein each second interface component includes a concave surface approximately corresponding to the cylindrical shape of each first interface component such that each first interface component fits at least partially within the corresponding second interface component when each first interface component is coupled to the corresponding second interface component; and
one or more attachment components each coupled to a second side of a corresponding rotatable component, wherein the one or more attachment components comprise one or more of a glove, one or more rings, or one or more cylinders with a closed end.

18. The system of claim 17, wherein each of the plurality of input interfaces is slideably coupled to the haptic device.

19. The system of claim 17, wherein each of the plurality of rotatable components includes a permanent magnet positioned adjacent to each second interface component, wherein each permanent magnet is coupled to a non-magnetic material, and wherein each permanent magnet has a different magnetic strength.

20. The system of claim 17, wherein the rotatable component includes a decoupling mechanism to removeably couple the permanent magnet from the non-magnetic material.
